(19) United States
(12) Patent Application Publication
(10) Pub. No.: US 2018/0174170 A1
(43) Pub. Date: Jun. 21, 2018

(54) Systems and Methods for Modeling Transaction Data Associated With Merchant Category Codes

(71) Applicant: MASTERCARD INTERNATIONAL INCORPORATED, Purchase, NY (US)

(72) Inventors: Walter F. Lo Faro, Chesterfield, MO (US); Joshua A. Allbright, Valley Park, MO (US)

(21) Appl. No.: 15/381,675

(22) Filed: Dec. 16, 2016

(51) Int. Cl. G06Q 30/02; G06Q 10/06

(52) U.S. Cl. CPC G06Q 30/0204; G06Q 10/067

(57) ABSTRACT

Systems and methods are provided for modeling transaction data associated with merchant category codes (MCCs) assigned to merchants. An example method includes accessing a transaction data structure having transaction data for a plurality of merchants, and accessing a merchant data structure including multiple merchants and a category descriptor for each of the multiple merchants. The method also includes combining data in the transaction data structure and the merchant data structure based on a merchant identifier for a merchant common thereto, and assigning a label to the common merchant based on at least one category descriptor for the common merchant in the merchant data structure. Further, the method includes generating a model for a MCC assigned to the common merchant, based on transaction data for the common merchant and the assigned label, whereby the model can be used to verify assignment of the MCC to other merchants.

### FIELD

The present disclosure generally relates to systems and methods for use in modeling data associated with assigned merchant category codes (MCCs), and in particular, to systems and methods for use in modeling transaction data for certain merchants identified to assigned MCCs and applying the resulting model(s) to evaluate the assigned MCCs of the certain merchants.

### BACKGROUND

This section provides background information related to the present disclosure which is not necessarily prior art.

Payment accounts are used by consumers to perform numerous different transactions including, for example, purchasing products (e.g., goods and/or services) from merchants, etc. Transaction data is often generated in connection with the transactions and stored in/by payment networks and/or parties associated with the payment network (e.g., issuers, acquires, etc.). The transaction data includes a variety of different types of data related to the transactions, including, for example, merchant category codes (MCCs) associated with the merchants involved in the transactions. MCCs are often relied on, in combination with a variety of other data included in the transaction data, to identify trends in transactions, per consumer or group of consumers, for example, whereby marketing, advertising or other services may be adjusted based on the identified trends.

### DRAWINGS

The drawings described herein are for illustrative purposes only of selected embodiments and not all possible implementations, and are not intended to limit the scope of the present disclosure.

FIG. 1 is a block diagram of an exemplary system of the present disclosure suitable for use in modeling transaction data associated with merchant category codes (MCCs) assigned to various multiple merchants;

FIG. 2 is a block diagram of an exemplary computing device that may be used in the system of FIG. 1;

FIG. 3 is an exemplary transaction data structure including transaction data related to multiple merchants, which may be stored in the system of FIG. 1 for use as described herein;

FIG. 4 is an exemplary merchant data structure of data related to multiple merchants, which may be stored in the system of FIG. 1 for use as described herein;

FIG. 5 is an exemplary method, which may be implemented via the system of FIG. 1, for modeling the transaction data associated with the MCCs assigned to the various multiple merchants; and

FIG. 6 is an exemplary combined data structure based on the transaction data structure of FIG. 3 and the merchant data structure of FIG. 4, as provided by the exemplary method of FIG. 5.

Corresponding reference numerals indicate corresponding parts throughout the several views of the drawings.

### DETAILED DESCRIPTION

Exemplary embodiments will now be described more fully with reference to the accompanying drawings. The description and specific examples included herein are intended for purposes of illustration only and are not intended to limit the scope of the present disclosure.

Transaction data is often compiled by payment networks, for example, in connection with payment device transactions by consumers at merchants. The transaction data may then be used, by the payment networks, to identify potential for consumers to make certain kinds of purchases. Separately, data related to certain merchants (e.g., data used in labeling the merchants, data relating to verified classifications of the merchants, etc.) is often compiled by a variety of different entities including, for example, the payment networks and/or third-party entities associated or unassociated with the payment networks (e.g., other independent data providers, etc.). Typically, the merchant data relating to the certain merchants may be limited in nature, for example, as compared to transaction data related to those same merchants. Uniquely, the systems and methods herein combine transaction data and merchant data related to particular merchants to aid in verifying merchant category codes (MCCs) assigned to the particular merchants. In particular, merchant data for a set of merchants is combined with transaction data for those merchants, where the merchant data is indicative of the MCCs of the merchants (or assigned to the merchants). When the set of merchants is confirmed as associated with a particular MCC, a model is then generated, by a verification engine, for the set of merchants associated with the MCC. The model is then applied, by the verification engine, to transaction data for a different set of merchants for which the same MCC is assigned, in order to provide a probability that the MCC for the different set of merchants is proper, or not. In this manner, merchant data for particular merchants is leveraged against transaction data for different merchants to provide a confidence in MCCs assigned to the different merchants (and/or a confidence in assigning MCCs to the merchants), whereupon the MCCs may be verified.

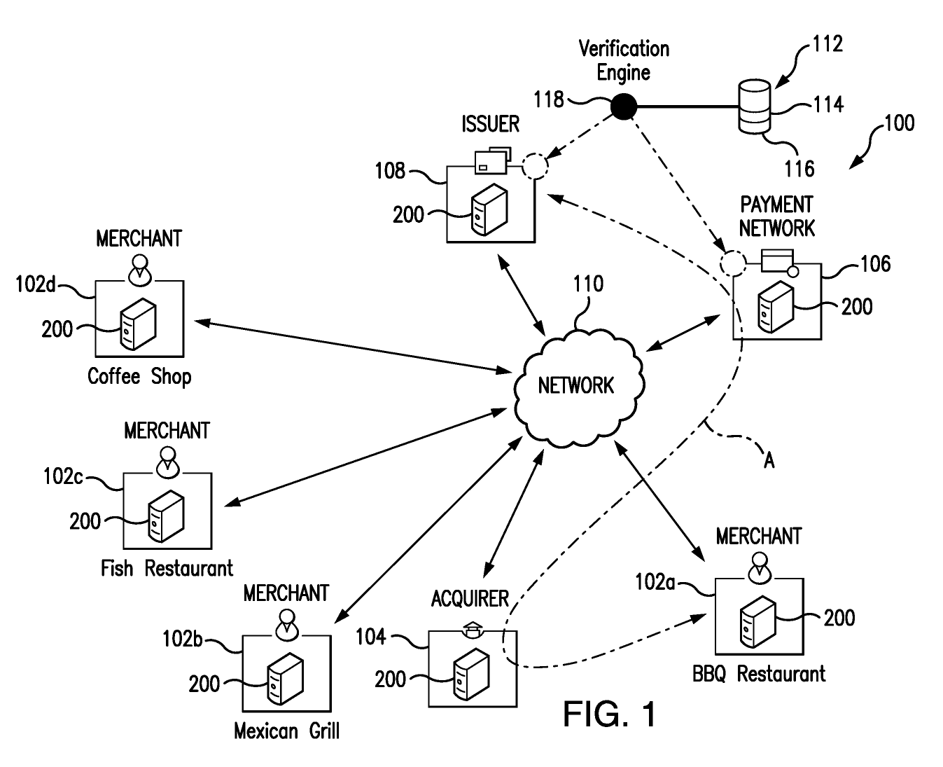

FIG. 1 illustrates an exemplary system 100 in which one or more aspects of the present disclosure may be implemented. Although parts of the system 100 are presented in one arrangement, it should be appreciated that other exemplary embodiments may include the same or different parts arranged otherwise, depending on, for example, processing of payment transactions, accessibility of third-party data, sources of such third-party data, etc.

As shown in FIG. 1, the illustrated system 100 generally includes multiple merchants 102a-d associated with providing products to consumers, an acquirer 104 associated with at least one of the merchants 102a-d, a payment network 106, and an issuer 108 associated with payment accounts used by consumers to perform transactions at the merchants 102a-d. Each of the merchants 102a-d, the acquirer 104, the payment network 106, and the issuer 108 is coupled to (and in communication with) a network 110. The network 110 may include, without limitation, a wired and/or wireless network, a local area network (LAN), a wide area network (WAN) (e.g., the Internet, etc.), a mobile network, and/or another suitable public and/or private network capable of supporting communication among two or more of the illustrated parts of the system 100, or any combination thereof. In one example, the network 110 includes multiple networks, where different ones of the multiple networks are accessible to different ones of the illustrated parts in FIG. 1. In particular in this example, the acquirer 104, the payment network 106, and the issuer 108 may be connected via a private payment transaction network that is part of network 110 for processing payment account transactions, and the merchants 102a-d may be connected with consumers for effecting payment account transactions, for example, through a public network, such as the Internet, that is also part of network 110.

In this exemplary embodiment, the merchants 102a-d represent multiple different merchants, and specifically, different types of merchants. In this example, for purposes of illustration, the merchant 102a is a BBQ restaurant; the merchant 102b is a Mexican grill; the merchant 102c is a fish restaurant; and merchant 102d is a coffee shop. Each of the merchants 102a-d provides products (e.g., goods and/or services, etc.) for purchase by a consumer (not shown). It should be appreciated that any number and/or type of merchants may be included in systems in other embodiments, and that the specific types and numbers of merchant described herein are merely exemplary.

In the system 100, a consumer is associated with a payment account, through which the consumer funds transaction with the merchants 102a-d for the purchase of products. In particular in the system 100, the payment account is provided (or issued) to the consumer by the issuer 108. The payment account, then, is generally represented by one or more payment devices that may be used by the consumers at the merchants 102a-d for the purchase of the products (e.g., payment cards, fobs, virtual payment devices contained in an electronic wallet, etc.).

In an exemplary transaction, the consumer may seek to purchase food from the BBQ restaurant merchant 102a, using the payment account to fund the purchase. As such, the consumer presents a payment device to the merchant 102a. The merchant 102a receives and/or retrieves credentials from the payment device, for example, at a point-of-sale (POS) terminal, and communicates an authorization request through the network 110 (along path A) to determine if the consumer's payment account is in good standing and if there is/are sufficient credit/funds to complete the transaction. The request generated by the merchant 102 generally includes an account number and an amount of the purchase, and may further include a merchant category code (MCC) (i.e., a MCC for the merchant 102a as programed into the POS terminal). In particular, the merchant 102a communicates the authorization request to the acquirer 104 who, in turn, communicates with the issuer 108, through the payment network 106 (again via the network 110), for authorization of the transaction. If the MCC for the merchant 102a is not included in the authorization request generated at the POS terminal, the acquirer 104 may append the MCC to the authorization request prior to communicating the authorization request to the payment network 106 and the issuer 108. In any case, the MCC, whether applied in the authorization request by the merchant 102a or appended by the acquirer 104, is generally assigned to the merchant 102a by the acquirer 104 generally based on the products provided by the merchant 102a.

If the issuer 108 accepts the transaction, an authorization reply is provided back to the merchant 102a (again, generally along path A) and the merchant 102a completes the transaction. The credit line or funds of the consumer, depending on the type of payment account, is then decreased by the amount of the purchase, and the charge is posted to the consumer's account associated with the payment device. The transaction is later cleared and settled by and between the merchant 102a and the acquirer 104 and by and between the acquirer 104 and the issuer 108 (in accordance with settlement arrangements, etc.). Conversely, if the issuer 108 declines the transaction, an authorization reply is provided back to the merchant 102a and the merchant 102a is able to terminate the transaction with the consumer, or request an alternate form of funding. Further, in the above transaction, fees are often exchanged among the merchant 102a, the acquirer 104, the payment network 106, and/or the issuer 108. In multiple embodiments, the fees associated with the transaction are based on a variety of factors, including, for example, the MCC included in the authorization request and/or assigned to the merchant 102, etc.

While described with reference to the merchant 102a, it should be appreciated that transactions between consumers and merchants 102b-d, and funded by payment accounts associated with the consumers, will be substantially consistent with the example transaction described above (and may include the same or different acquirers, payment networks, and/or issuers, etc.), depending on the payment account, the consumer, and/or the particular ones of the merchants 102b-d involved, for example.

Transaction data is generated, collected, and stored as part of the above interactions among the merchant 102a (and for similar transactions involving the other merchants 102b-d), the acquirer 104, the payment network 106, the issuer 108, and the consumer. The transaction data represents at least a plurality of transactions, e.g., completed transactions, attempted transactions, etc. The transaction data, in this exemplary embodiment, is stored at least by the payment network 106 (e.g., in a data structure associated with the payment network 106, etc.). Additionally, or alternatively, the acquirer 104 and/or the issuer 108 may store the transaction data, or part thereof, in a data structure. The transaction data may be stored in any desired manner in the system 100. With that said, transaction data may include, for example, payment account numbers, amounts of transactions, merchant IDs, MCCs, region codes for merchants involved in transactions and/or POS terminals associated with the merchants (or other merchant location identifiers and/or transaction location identifiers), merchant DBA names, dates/times of transactions, products purchased and related descriptions or identifiers, etc. It should be appreciated that more or less information related to transactions, as part of either authorization and/or clearing and/or settling, may be included in transaction data and stored within the system 100, at the merchants 102a-d, the acquirer 104, the payment network 106, and/or the issuer 108. Further, transaction data, unrelated to a particular payment account, and/or merchant data related to one or more of the merchants 102a-d may be collected by a variety of techniques, and similarly stored within the system 100.

In various exemplary embodiments, consumers involved in the different transactions herein are prompted to agree to legal terms associated with their payment accounts, for example, during enrollment in their accounts, etc. In so doing, the consumers and merchants may voluntarily agree, for example, to allow issuers of the payment accounts, payment networks, etc., to use data collected during enrollment and/or collected in connection with processing the transactions, subsequently for one or more of the different purposes described herein.

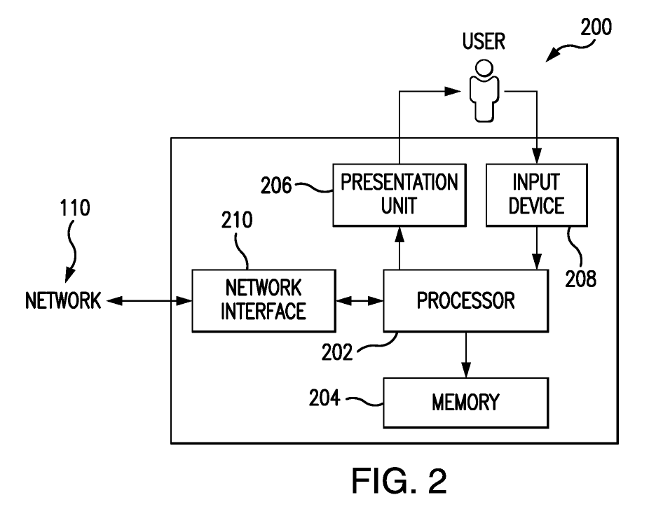

FIG. 2 illustrates an exemplary computing device 200 that can be used in the system 100. The computing device 200 may include, for example, one or more servers, workstations, personal computers, laptops, tablets, smartphones, POS terminals, other suitable computing devices, etc. In addition, the computing device 200 may include a single computing device, or it may include multiple computing devices located in close proximity, or multiple computing devices distributed over a geographic region, so long as the computing devices are specifically configured to function as described herein. In the system 100, each of the merchants 102a-d, the acquirer 104, the payment network 106, and the issuer 108 are illustrated as including, or being implemented in, computing device 200, coupled to the network 110. However, the system 100 should not be considered to be limited to the computing device 200, as described below, as different computing devices and/or arrangements of computing devices may be used.

Referring to FIG. 2, the exemplary computing device 200 generally includes a processor 202 and a memory 204 coupled to (and in communication with) the processor 202. The processor 202 may include one or more processing units (e.g., in a multi-core configuration, etc.) including, without limitation, a central processing unit (CPU), a microcontroller, a reduced instruction set computer (RISC) processor, an application specific integrated circuit (ASIC), a programmable logic device (PLD), a gate array, and/or any other circuit or processor capable of the functions described herein. The above examples are exemplary only, and are not intended to limit in any way the definition and/or meaning of processor.

The memory 204, as described herein, is one or more devices that permit data, instructions, etc., to be stored therein and retrieved therefrom. The memory 204 may include one or more computer-readable storage media, such as, without limitation, dynamic random access memory (DRAM), static random access memory (SRAM), read only memory (ROM), erasable programmable read only memory (EPROM), solid state devices, flash drives, CD-ROMs, thumb drives, floppy disks, tapes, hard disks, and/or any other type of volatile or nonvolatile physical or tangible computer-readable media. The memory 204, and/or data structures included therein, may be configured to store, without limitation, transaction data structures, merchant data structures, models, and/or other types of data and/or information suitable for use as described herein. Furthermore, in various embodiments, computer-executable instructions may be stored in the memory 204 for execution by the processor 202 to cause the processor 202 to perform one or more of the functions described herein, such that the memory 204 is a physical, tangible, and non-transitory computer readable storage media. It should be appreciated that the memory 204 may include a variety of different memories, each implemented in one or more of the functions or processes described herein.

The computing device 200 also includes a presentation unit 206 (or output device or display device) that is coupled to (and is in communication with) the processor 202 (however, it should be appreciated that the computing device 200 could include output devices other than the presentation unit 206, etc.). The presentation unit 206 outputs information, either visually or audibly to a user of the computing device 200, for example, a user associated with the payment network 106 in the system 100 or the issuer 108, individuals associated with other parts of the system 100, etc. It should be further appreciated that various interfaces may be displayed at computing device 200, and in particular at presentation unit 206, to display information, such as, for example, transaction data, merchant data, etc. The presentation unit 206 may include, without limitation, a liquid crystal display (LCD), a light-emitting diode (LED) display, an organic LED (OLED) display, an “electronic ink” display, etc. In some embodiments, presentation unit 206 includes multiple devices.

The computing device 200 further includes an input device 208 that receives inputs from the user of the computing device 200 (i.e., user inputs) such as, for example, selection of certain MCCs, merchants, etc. The input device 208 is coupled to (and is in communication with) the processor 202 and may include, for example, a keyboard, a pointing device, a mouse, a stylus, a touch sensitive panel (e.g., a touch pad or a touch screen, etc.), another computing device, and/or an audio input device. In various exemplary embodiments, a touch screen, such as that included in a tablet, a smartphone, or similar device, behaves as both a presentation unit 206 and an input device 208.

In addition, the illustrated computing device 200 also includes a network interface 210 coupled to (and in communication with) the processor 202 and the memory 204. The network interface 210 may include, without limitation, a wired network adapter, a wireless network adapter, a mobile network adapter, or other device capable of communicating to one or more different networks, including the network 110. Further, in some exemplary embodiments, the computing device 200 includes the processor 202 and one or more network interfaces incorporated into or with the processor 202.

Referring again to FIG. 1, the system 100 further includes a data structure 112, which is stored in memory, such as, for example, memory 204. The data structure 112, while illustrated as an independent and separate part of the system 100, is generally incorporated into the payment network 106 (e.g., in memory 204 of the computing device 200 associated with the payment network 106, etc.), into the issuer 108 (e.g., in memory 204 of the computing device 200 associated with the issuer 108, etc.), and/or into one or more third parties (not shown) that provide merchant data used in the system 100 (as described herein), or even potentially verification engine 118 of the system 100 described below.

The data structure 112 generally includes multiple structures, each potentially comprising multiple segments. As shown in FIG. 1, in the illustrated embodiment, the data structure 112 is segregated into two structures: a transaction data structure 114 and a merchant data structure 116. Various different types of data associated with transactions to payment accounts and/or with the merchants 102a-d is stored in one (or more) of the different data structures 114, 116, as described below (e.g., transaction data, merchant data, etc.). As an example, the transaction data structure 114 may include known, factual average daily frequency data for the merchants 102a-d, separated into hourly buckets. That is, the transaction data structure 114 may include, for example, for each of the merchants 102a-d, a vector of twenty-four known values representing average daily frequency data for each hour for each of the given merchants 102a-d (which may then be used, for example, in generating a model relating to the MCCs of the merchants 102a-d, as described more below).

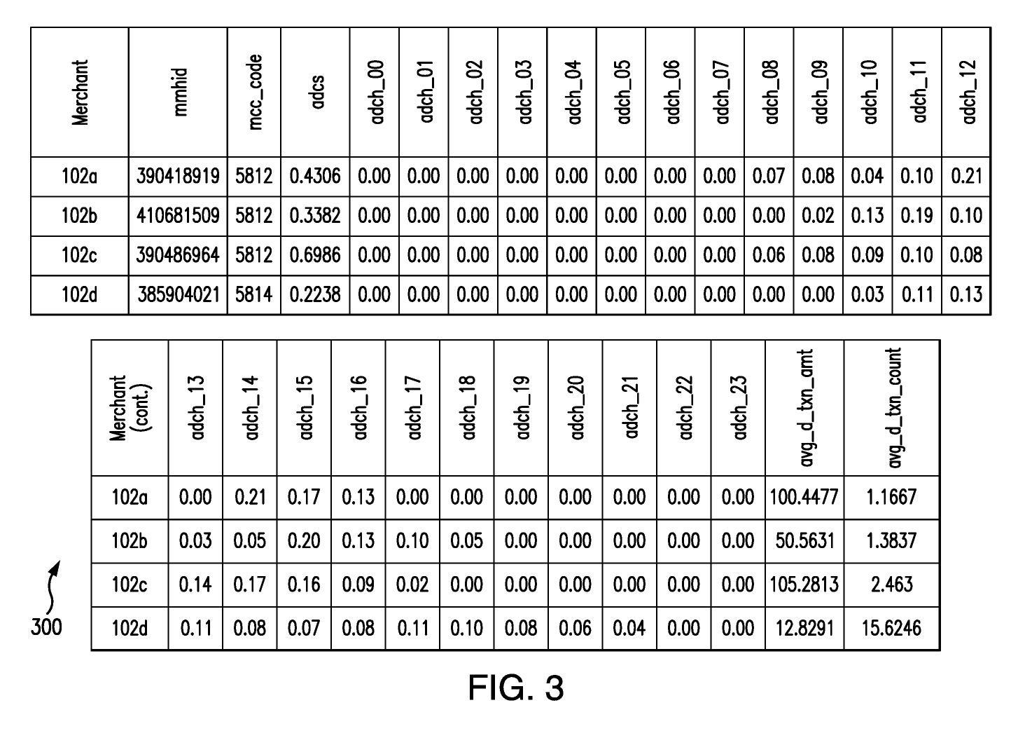

FIG. 3 illustrates an example segment 300 of the transaction data structure 114, of the data structure 112. The segment 300 generally includes identifying data and transaction data for each of the merchants 102a-d. For example, the merchant 102a is included in the first row and is identified by a merchant market hierarchy identifier (mmhid) of 385944444. As shown, the merchant 102a is assigned to MCC 5812. Further, the merchant 102a includes an average debit-credit score (adcs) of 0.4306, and an average number of transactions per hour (as indicated in columns adch_00-adch_23) ranging from 0.00 to 0.21. In connection with the average number of transactions per hour, it should be appreciated that the hours designation is relative to the 24 hour clock, where 00 is midnight and 020 is 8:00 PM, etc. Finally, in this example, the segment 300 includes an average daily transaction amount (avg_d_txn_amt) and an average daily transaction count (avg_d_txn_count), which for the merchant 102a is 100.4477 and 1.1667, respectively. Similar data is included in the segment 300, and shown in FIG. 3, for each of the other merchants 102b-d in the system 100.

It should be appreciated that in other embodiments, the transaction data structure 114, of the data structure 112 in the system 100, may include the same, different, additional, or less data (e.g., transaction data and/or identifying/merchant data etc.), as compared to the data included in the illustrated data structure segment 300. For example, rather than daily data, the transaction data may include hourly, weekly, or monthly, or some other interval of data for the merchants 102a-d. In addition, in other embodiments, the transaction data structure 114 may further include demographic data related to consumers (e.g., age, gender, etc.), product data for products purchased by consumers at the merchants 102a-d, etc., which may be used as described below.

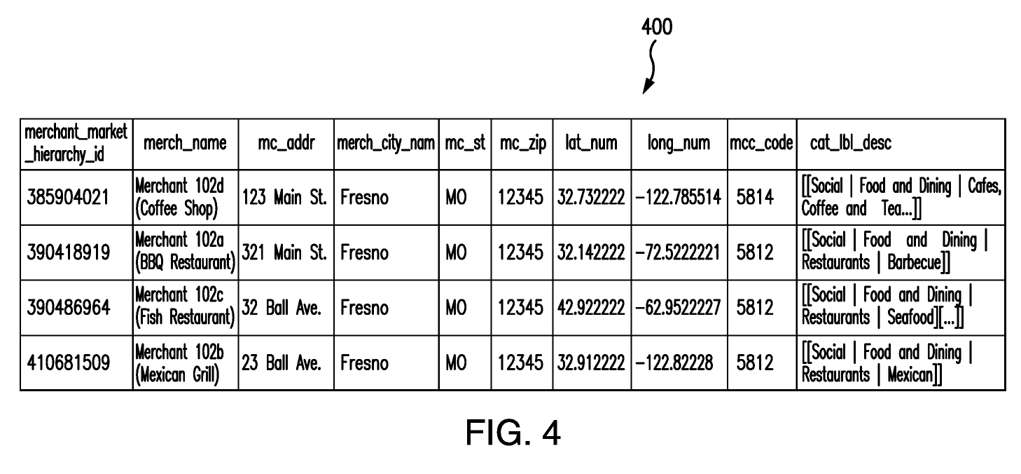

FIG. 4 illustrates an example segment 400 of the merchant data structure 116, of the data structure 112. The segment 400 includes identifying data and merchant data for each of the merchant's 102a-d (e.g., factual data known to be accurate for the merchants 102a-d, etc.). Specifically, the segment 400 includes the merchant market hierarchy identifier (mmhid) for each of the merchants 102a-d, as well as the merchant's name (merch_name), the merchant's address (mc_addr), the merchant's city (mc_city_name), the merchant's state (mc_st), and the merchant's zip code (mc_zip). The merchant's latitude and longitude are also included in the segment 400 (lat_num and long_num, respectively). In addition, the segment 400 includes the MCC for each of the merchants 102a-d (mcc_code), and category label descriptors (cat_lbl_desc). With that said, the identifying and merchant data included in the segment 400 is merely exemplary and the same, other, different or additional data may be included in merchant data structures in other embodiments.

It should be appreciated that the merchant data structure 116 may be defined by and/or specific to a source or sources of data included therein. The source or sources of data may include third party sources, such as, for example, third party data aggregators (e.g., Factual Inc.; Dun and Bradstreet, Inc.; Pitney Bowes Inc.; YP LLC; Google Places; etc.), or may include one or more of the entities in FIG. 1 or service providers (not shown) thereto. Regardless of the sources, as used herein, the merchant data structure 116 includes at least terms and/or phrases (broadly, descriptors) indicative of a kind, type, and/or category, etc. of the merchants included therein (e.g., as included in the category descriptors column in the segment 400, etc.).

With reference again to FIG. 1, the verification engine 118 of the system 100 is configured, for example, by computer executable instructions, to perform the operations described herein. As shown, the verification engine 118 is coupled to the data structure 112 in the system 100 and is a standalone device (and, for example, is consistent with computing device 200, etc.). Nonetheless, as indicated by the dotted lines, the verification engine 118 may be incorporated into the payment network 106 and/or the issuer 108 (e.g., as part of the corresponding computing device 200, etc.), or further, into other entities in the system 100 or even other entities not in the system 100, depending on, for example, a coordinator of verification operations and/or accessibility of transaction data and/or merchant data included in the data structure 112. Moreover, in various embodiments, when the engine 118 is integrated into the payment network 106 and/or the issuer 108, the data structure 112 is likewise integrated therewith. Similarly, when the engine 118 is standalone, generally, the data structure 112 is similarly standalone and/or incorporated into the engine 118 (although such configurations are not required in all embodiments).

In this exemplary embodiment, the verification engine 118 is configured to combine the transaction data structure 114 and the merchant data structure 116, to append labels to the merchants 102a-d, and to then model the transaction data for the same/like categories of the merchants 102a-d (e.g., for ones of the merchants 102a-d that have the same MCCs, etc.).

Specifically, for example, the verification engine 118 is configured to combine the data structures 114, 116 based on identifiers associated with the merchants 102a-d and included in both data structures 114, 116 (e.g., mmhid, etc.). The identifiers (also referred to as merchant identifiers herein) may include numerical and/or alpha-numerical values, merchant locations (e.g., street address, latitude/longitude, etc.), or other information unique or at least partially unique to the merchants 102a-d, etc. As such, data from both of the data structures 114, 116 is available to the verification engine 118 for subsequent use.

In addition, for example, the verification engine 118 is configured to append (or assign) labels to the merchants 102a-d based on the category label descriptors provided in the merchant data structure 116, of the data structure 112 (e.g., the category label descriptors in the cat_lbl_descr column of the segment 400, etc.). This provides correct labeling for the merchants 102a-d, for example, on which the subsequent modeling (as described hereinafter) can be based. Such configuration for appending/assigning the labels may be provided via the following exemplary code segment:

```
import numpy as np
import pandas as pd
import matplotlib.pyplot as plt
import warnings
from sklearn import preprocessing
warnings.simplefilter(‘ignore’, DeprecationWarning)
%matplotlib inline
pd.set_option(‘display.max_columns’, None)
pd.set_option(‘display.max_rows’, None)
df = pd.read_csv(‘merchant_profiles.csv’)
#assign labels based on merchant categories
def implied_bar(row):
  if row[‘s_bar’] == 1 or row[‘s_bar_hotel’] == 1 or row[‘s_bar_jazz_blues_cafe’] == 1 or
row[‘s_bar_sports_bar’] == 1 or row[‘s_bar_wine_bar’] == 1:
    return ‘bar’
  else:
    return ‘other’
def implied_ff(row):
  if row[‘implied_cat’]!=‘bar’ and (row[‘s_fd_rr_fast_food’]==1):
    return ‘fastfood’
  else:
    return row[‘implied_cat’]
def implied_rest(row):
  if row[‘implied_cat’] not in [‘bar’,‘fastfood’] and (row[‘s_fd_rr’]==1 or
row[‘s_fd_rr_american’]== 1 or row[‘s_fd_rr_asian’]== 1 or row[‘s_fd_rr_barbecue’]== 1
or row[‘s_fd_rr_buffet’] == 1 or row[‘s_fd_rr_burger’] == 1 or row[‘s_fd_rr_chinese’] ==
1 or row[‘s_fd_rr_deli’] == 1 or row[‘s_fd_rr_diner’]== 1 or row[‘s_fd_rr_fast_food’]== 1
or row[‘s_fd_rr_food_truck’] == 1 or row[‘s_fd_rr_french’] == 1 or row[‘s_fd_rr_indian’]
== 1 or row[‘s_fd_rr_international’]== 1 or row[‘s_fd_rr_italian’] == 1 or
row[‘s_fd_rr_japanese’] == 1 or row[‘s_fd_rr_korean’] == 1 or row[‘s_fd_rr_mexian’] ==
1 or row[‘s_fd_rr_middle_eastern’] == 1 or row[‘s_fd_rr_pizza’]== 1 or
row[‘s_fd_rr_seafood’] == 1 or row[‘s_fd_rr_steakhouse’] == 1 or row[‘s_fd_rr_sushi’]==
1 or row[‘s_fd_rr_thai’] == 1 or row[‘s_fd_rr_vegan_veget’] == 1):
    return ‘restaurant’
  else:
    return row[‘implied_cat’]
def implied_other(row):
  if row[‘s_fd_coffee_tea_house’] == 1 or row[‘s_e’] ==1 or row[‘s_e_amusement_part’]
== 1 or row[‘s_e_arcades’] == 1 or row[‘s_e_billiard’] or row[‘s_e_bingo’] == 1 or
row[‘s_e_bowling’] == 1 or row[‘s_e_casino’] == 1 or row[‘s_e_hookah’] or
row[‘s_e_karaoke’] == 1 or row[‘s_e_movie_theatres’] == 1 or row[‘s_e_music_venues’]
== 1 or row[‘s_e_night_club’] == 1:
    return ‘other’
  else:
    return row[‘implied_cat’]
def implied_rest_flag(row):
  if row[‘implied_cat’] == ‘restaurant’:
    return 1
  else:
    return 0
def implied_bar_flag(row):
  if row[‘implied_cat’] == ‘bar’:
    return 1
  else:
    return 0
def implied_ff_flag(row):
  if row[‘implied_cat’] == ‘fastfood’:
    return 1
  else:
    return 0
def not_open_evening(row):
  if row[‘implied_cat’] == “restaurant” and (row[‘adch_18’] == 0 or row[‘adch_19’] == 0
or row[‘adch_20’] == 0):
    return ‘other’
  else:
    return row[‘implied_cat’]
def mcc_exclusion(row):
  if row[‘mcc_code’] in
(7399,5541,5422,5811,5999,5399,5411,4214,5969,7991,5499,7298,5499,7997,7311,7996,
5462):
    return ‘other’
  else:
    return row[‘implied_cat’]
%time df[‘implied_cat’] = df.apply(implied_bar, axis=1)
%time df[‘implied_cat’] = df.apply(implied_ff, axis=1)
%time df[‘implied_cat’] = df.apply(implied_rest, axis=1)
%time df[‘implied_cat’] = df.apply(implied_other, axis=1)
#mcc exclusion
%time df[‘implied_cat’] = df.apply(mcc_exclusion, axis=1)
#not open during 6pm - 8pm
%time df[‘implied_cat’] = df.apply(not_open_evening, axis=1)
%time df[‘implied_cat_int’] =
df.replace(to_replace=[‘bar’,‘fastfood’,‘resteraunt’,‘other’],v alue=[0,1,2,−1])[‘implied_cat’]
%time df[‘implied_rest_only’] = df.apply(implied_rest_flag, axis=1)
%time df[‘implied_ff_only’] = df.apply(implied_ff_flag, axis=1)
%time df[‘implied_bar_only’] = df.apply(implied_bar_flag, axis=1)
```

It should be appreciated that the above code segment is provided for purposes of illustration only and is not intended to limit the present discourse. A variety of code segments and/or logic therein may be provided to label the merchants 102a-d in the system 100, using these of other labels, for example, based on a variety of data included in the compiled data structure 112 (and, particularly, in the merchant data structure 116).

Further, for example, the verification engine 118 is configured to generate one or more models of (or based on) the transaction data for the merchants 102a-d assigned to a particular label and/or MCC (e.g., via a regression model, via support vector machines (SVM) with stochastic gradient descent (SGD), random forest, combinations thereof, etc.). In this exemplary embodiment, the verification engine 118 may be configured to generate a model for one or more of the merchants 102a-d having (or assigned) a particular MCC, via the following exemplary code segment:

```
#logistic Regression Model
from sklearn.linear_model import LogisticRegression
from sklearn import metrics as mt
lr_clf = LogisticRegression(penalty=‘l2’, C=1, class_weight=None)
iter_num=0
%time lr_clf.fit(X_train,y_train) # train object
y_hat = lr_clf.predict(X_test) # get test set precitions
# accuracy and conf matrix
acc = mt.accuracy_score(y_test,y_hat)
conf = mt.confusion_matrix(y_test,y_hat)
print(“accuracy”, acc)
print(“confusion matrix\n”,conf)
#SVM with SGD
from sklearn.linear_model import SGDClassifier
regularize_const = .1
iterations = 10
svm_sgd = SGDClassifier(alpha=regularize_const,
    fit_intercept=True, l1_ratio=1.0, learning_rate=‘optimal’,
    loss=‘hinge’, n_iter=iterations, n_jobs=−1, penalty=‘l1’)
svm_sgd.fit(X_train,y_train)
y_hat = svm_sgd.predict(X_test)
conf = mt.confusion_matrix(y_test, y_hat)
acc = mt.accuracy_score(y_test, y_hat)
print(‘accuracy:’, acc)
print(“confusion matrix\n”,conf)
#Random Forest
from sklearn.ensemble import RandomForestClassifier
#r_clf = RandomForestClassifier(max_depth=50, n_estimators=150,
n_jobs=−1, oob_score=True)
r_clf = RandomForestClassifier(n_estimators=150, n_jobs=−1,
oob_score=True)
# now iterate through and get predictions, saved to the correct row in yhat
# for train, test in cv:
%time r_clf.fit(X_train,y_train)
y_hat = r_clf.predict(X_test)
conf = mt.confusion_matrix(y_test,y_hat)
acc = mt.accuracy_score(y_test, y_hat)
print(‘accuracy:’, acc)
print(“confusion matrix\n”,conf)
```

It should again be appreciated that the above code segment is provided for purposes of illustration only and is not intended to limit the present discourse. A variety of code segments and/or logic therein may be provided to model the transaction data included in the data structure 112 (and more particularly in the transaction data structure 114), for example, based on a variety of data included in the data structure 112.

As is apparent from the above, to model the transaction data for the merchants 102a-d, the verification engine 118 is configured to apply one or more of simple logistic regression, support vector machines with stochastic gradient descent, and random forest models to a training subset of the combined data structure 112, and also to evaluate the model on a test subset of the combined data structure 112. With that said, it should be appreciated that the transaction data in the combined data structure 112 (e.g., in the transaction data structure 114 thereof, etc.) may be modeled in any number of different manners using, for example, machine learning algorithms that take in, as input, feature vectors and labels and build a model that describes a relationship between the input features and labels. As such, it should again be appreciated that the code segment provided above is for purposes of illustration and is not intended to limit the present disclosure. Further, in at least one embodiment, the verification engine 118 is not configured (or specifically configured) to generate a model, but instead is configured to expose the combined data structure 112 to one or more other engines, computing devices (e.g., computing device 200, etc.), and/or entities (not shown), which are provided, then, to generate one or more models as described herein.

In any case, once the model is generated (and tested), the verification engine 118 is configured to deploy and/or expose the model to one or more entities. In doing so, the model is applied, by one or more computing devices (e.g., by the verification engine 118, etc.), to provide a confidence score for other merchants in one or more of the same MCCs as merchants 102a-d. Specifically, for example, when the transaction data included in the model for another merchant (e.g., transaction count per hour (or day), average daily credit share, average daily amount and/or count, etc.), for a given MCC, matches and/or substantially matches the transaction data for one or more of the merchants 102a-d (used to generate the model), the model returns (or assigns) a score indicative of the MCC being properly assigned to the merchant (e.g., returns a relatively high score (e.g., on a scale of 0 to 1, etc.), etc.). Such matches and/or substantial matches may include the score from the model satisfying (e.g., being greater than, etc.) a predefined threshold, etc. (e.g., the greater the score, the more likely the MCC assigned to the merchant (being evaluated by the model) is the one the model is predicting for the merchant, based on the transaction data included in the model; etc.). Conversely, when the transaction data included in the model for another merchant, assigned to a given MCC consistent with the model, diverges substantially from the model (e.g., failing to satisfy (e.g., being below, etc.) the predefined threshold, is below another predefined threshold, etc.), the assigned MCC for the merchant is given a score indicating the MCC is likely erroneously assigned to the merchant (e.g., a relatively low score (e.g., on a scale of 0 to 1, etc.), etc.). In such case, the payment network 106 (or other part of the system 100) may assign a different MCC to the merchant.

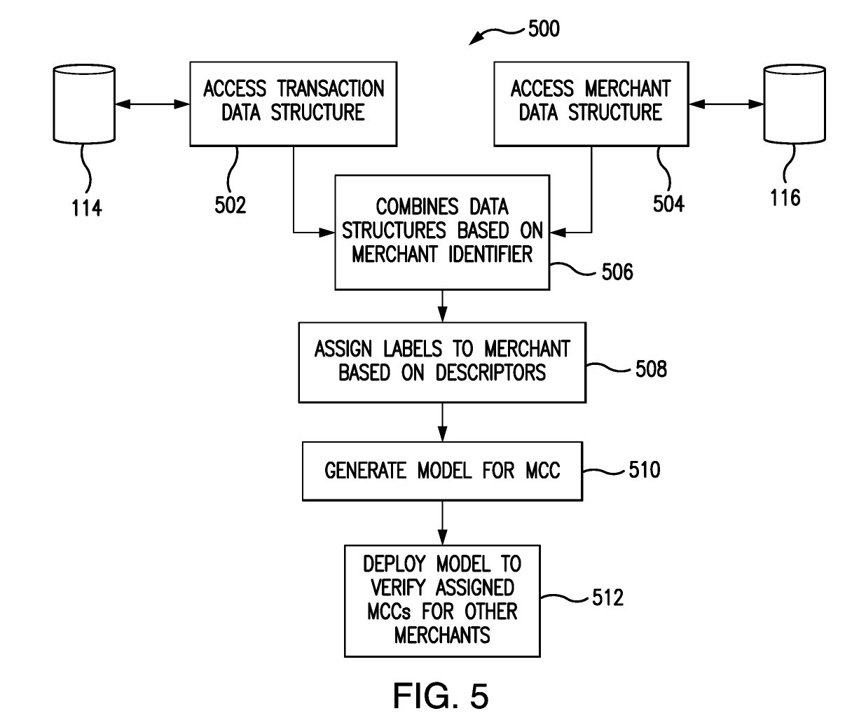

FIG. 5 illustrates an exemplary method 500 for evaluating, and verifying, assigned MCCs for merchants based on transaction data associated with the merchants. The exemplary method 500 is described as implemented in the system 100 and, more particularly, in the verification engine 118 therein. Further, for purposes of illustration, the exemplary method 500 is described herein with reference to other parts of the system 100 and to the computing device 200, and also to the segments 300, 400 of the data structures 114, 116, respectively. Nonetheless, as should be understood, the methods herein are not limited to the exemplary system 100, the exemplary computing device 200, or the exemplary segments 300, 400 and, similarly, the systems, the computing devices, and the data structures herein are not limited to the exemplary method 500.

At 502 in the method 500, the verification engine 118 accesses the transaction data structure 114, of the data structure 112. The transaction data structure 114 may be accessed in local memory, such as for example, memory 204, or remote memory in one or more other computing devices (e.g., computing device 200), associated with the verification engine 118, the payment network 106, the issuer 108, or otherwise. In general, as described above, the transaction data structure 114 includes certain data related to transactions at one or more merchants (e.g., merchant 102a-d, etc.). As part of accessing the transaction data structure 114, the verification engine 118 may filter the data included in the data structure 112 (which includes the transaction data structure 114), as appropriate, for a particular task, identified by a user. For example, when attempting to evaluate MCCs for fast food merchants, restaurant merchants, and bar merchants, the verification engine 118 may filter the data structure 112 based on MCCs 5812, 5813, and 5814. It should be appreciated that additional or alternative filtering may be employed, or not, depending on, for example, one or more user inputs, the particular MCCs to be evaluated/verified, etc. For example, the data structure 112 (including the transaction data structure 114 and the merchant data structure 116) may additionally (or alternatively) be filtered by geographic location (e.g., postal code, state, country, region, etc.), by merchant name, by transaction counts and/or amounts per interval (e.g., daily, weekly, monthly, etc.), etc.

The verification engine 118 also accesses the merchant data structure 116, of the data structure 112, at 504. Consistent with the above, the verification engine 118 may access the merchant data structure 116 from a local memory, such as, for example, memory 204, or another memory, such as a remote memory, associated with one or more other computing devices (e.g., computing device 200, etc.). The merchant data structure 116 may be populated based on one or more interactions associated with the payment network 106, and/or may be populated from one or more sources separate from and/or unrelated to the payment network 106. In one example, the merchant data structure 116 is populated from social media sources, consumer reviews, and/or reporting sources, etc. Further, as described above, the data structure 112 (including the merchant data structure 116) may be filtered, by the verification engine 118, based on one or more factors and/or limitations, as necessary or desired.

Once the data structure 112 is accessed (including the transaction data structure 114 and the merchant data structure 116), the verification engine 118 combines the data structures 114, 116, at 506. In particular, the verification engine 118 identifies a merchant identifier (e.g., a mmhid, etc.) and combines the data from both data structures 114, 116 into a single data structure based on that merchant identifier. In doing so, the verification engine 118 may append the merchant data structure 116 to the transaction data structure 114, or vice-versa. Or, the verification engine 118 may compile a new data structure based on the desired data from the two data structures 114, 116. The resulting combined data structure, then, includes data for a given merchant (and, potentially, multiple merchants).

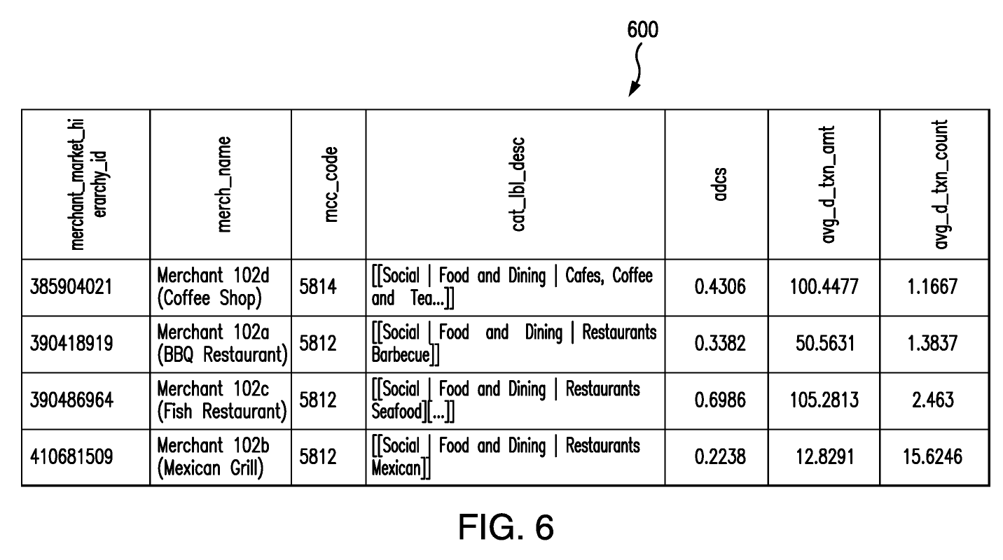

As an example, FIG. 6 illustrates a combined data structure segment 600 based on the transaction data structure segment 300 of FIG. 3 and the merchant data structure segment 400 of FIG. 4. As shown, in this exemplary combination, the segment 600 includes certain information from each of the segments 300, 400 (specifically, from each of the data structures 114, 116), but not all of the data. Other combinations, with more or less data, may be compiled in other embodiments to include other data, less data, more data (e.g., all available data, etc.), etc. for the merchants 102a-d, and potentially substantially only the data relied on by the verification engine 118 for each of the merchants. Nonetheless, it should be appreciated that the combined data structure segment 600 is merely exemplary and that the data structure segment 600 may be different, may contain more or less data, and/or may define a different form or format in other embodiments.

Referring again to FIG. 5, the verification engine 118 next assigns labels to the identified merchant in the combined data structure, at 508, based on the descriptors from the merchant data structure 116 (e.g., the category label descriptors, etc.). In particular, the evaluation engine 118 employs a logic sequence to determine which descriptors should be applied to the identified merchant (e.g., based on logic expressed in syntactically correct if/then/else statements, etc.). Example labels may include, without limitation, bar, fast food restaurant, restaurant, other, etc. Table 1 illustrates an example logic sequence that may be applied. In this exemplary embodiment, the descriptors for the merchant are assigned in an array, where “0” indicates the descriptor is applicable and “1” indicates the descriptor is inapplicable. Based on the logic sequence in Table 1, the merchant 102a may be assigned a label “other,” and each of the merchants 102b-d may be assigned a label “restaurant.”

TABLE 1
Logic Sequence
Is it a bar?
If not, is it a fast food restaurant?
If not, is it a restaurant?
If not, it is “other.”

It should be appreciated that, while the method 500, as illustrated, combines the data structures 114, 116 and then assigns labels, the labels may be assigned prior to combining the data structures 114, 116 in other embodiments.

In any case, once the data structures 114, 116 are combined and the merchant is labeled, the verification engine 118 generates a model, at 510, for the specific MCC assigned to the merchant within the combined data structure. Specifically, for example, as described above, the verification engine 118 utilizes a machine learning algorithm (e.g., logistic regression, support vector machines, random forest, etc.) configured to receive merchant data for the merchant and the assigned label, and build a model that describes a relationship between the data and the label. In so doing, the verification engine 118 generally trains the particular model based on the known input data and then uses the model to generate scores for merchants that have not previously been seen by the model.

It should be appreciated that the model may be generated, by the verification engine 118, at one or more regular or irregular intervals.

Then in the method 500, the verification engine 118 deploys the model, at 512, to verify the particular MCC as assigned to other merchants. Specifically, the merchant data structure 116 often may include far fewer merchant entries than the transaction data structure 114. As such, when combined, the resulting combined data structure will include a number of entries consistent with the merchant data structure 116, for example, and the model will be built independent of the un-combined merchant entries in the transaction data structure 114. To deploy the model, therefore, the verification engine 118 may run the model against the remaining data in the transaction data structure 114 for other merchants having the specific MCC associated with the model, thereby providing a confidence score for the specific MCC based on the model.

In one example, the model may include a logistic regression model (with a probability output of 0 to 1), and may be used to verify an MCC of 5812 assigned to Merchant 1. Here, the model may result in a score of 0.997, indicating a high confidence that the assigned MCC of 5812 is correct. In another example, the model may be used to verify an MCC of 5812 assigned to Merchant 2. Here, the model may result in a score of 0.3345, indicating a low confidence that the assigned MCC of 5812 is correct (i.e., indicating that the assigned MCC is not correct). Thresholds used to determine such high confidence and low confidence, in this example, may be determined by a domain expert analyzing a false positive rate at various thresholds and then selecting a most accurate threshold, or by determining costs of false positives and false negatives and optimizing the cutoff. Further, when confidence in a MCC assigned to a merchant is low (e.g., below a threshold, of relatively low compared to other merchants assigned to the same MCC, etc.), one or more additional models (for other MCCs) may be run against the merchant's transaction data to identify a model, and an associated MCC, for which a higher confidence and/or score is provided. The MCC of that model may, then, be recommended as a replacement option for the merchant, for the low confidence MCC.

In various embodiments, the verification engine 118 may also (or alternatively) deploy the model to the payment network 106 and/or the issuer 108 (when not incorporated therein) (or other payment networks and/or issuers) for use in verifying the MCC associated with the model and assigned to other merchants.

In view of the above, the systems and methods herein provide models, which are based on transaction data involving particular MCCs assigned to merchants and which are verified by third party data related to the merchants. The models are then usable to provide a confidence and/or to verify the assignment of the same modeled MCCs to other merchants. In this manner, the MCCs assigned to certain merchant are verified while MCCs assigned to other merchant may be flagged for further review and/or change. The models, or different modes for different MCCs, may even be used to recommend MCCs that most closely match transaction data of merchants. Consequently, by generation and use of the models, inaccuracies in the MCCs assigned to merchants may be reduced, whereby reliance on the MCCs for certain operations (e.g., assigning interchange fees, marketing, advertising, etc.) may be more accurate and/or proper.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

It should be appreciated that one or more aspects of the present disclosure transform a general-purpose computing device into a special-purpose computing device when configured to perform the functions, methods, and/or processes described herein.

As will be appreciated based on the foregoing specification, the above-described embodiments of the disclosure may be implemented using computer programming or engineering techniques including computer software, firmware, hardware or any combination or subset thereof, wherein the technical effect may be achieved by performing at least one of: (a) accessing a transaction data structure having transaction data for a plurality of merchants; (b) accessing a merchant data structure, the merchant data structure including multiple merchants and at least one category descriptor for each of the multiple merchants; (c) combining data in the transaction data structure and the merchant data structure, based on a merchant identifier for a merchant common among at least one of the plurality of merchants in the transaction data structure and at least one of the multiple merchants in the merchant data structure; (d) assigning at least one label to the common merchant based on at least one category descriptor for the common merchant in the merchant data structure; and (e) generating a model for a MCC assigned to the common merchant, based on transaction data for the common merchant and the assigned at least one label, whereby the model can be used to verify assignment of the MCC to other merchants.

Example embodiments are provided so that this disclosure will be thorough, and will fully convey the scope to those who are skilled in the art. Numerous specific details are set forth, such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “connected to,” “coupled to,” or “in communication with” another feature, it may be directly on, connected or coupled to, or in communication with the other feature, or intervening features may be present. In contrast, when a feature is referred to as being “directly on,” “directly connected to,” “directly coupled to,” or “directly in communication with” another feature, there may be no intervening features present. As used herein, the term “and/or” includes any and all combinations of one or more of the associated listed items.

In addition, as used herein, the term product may include a good and/or a service.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature could be termed a second feature without departing from the teachings of the example embodiments.

None of the elements recited in the claims are intended to be a means-plus-function element within the meaning of 35 U.S.C. § 112(f) unless an element is expressly recited using the phrase “means for,” or in the case of a method claim using the phrases “operation for” or “step for.”

What is claimed is:

1. A computer-implemented method for use in modeling transaction data associated with merchant category codes (MCCs) assigned to merchants, the method comprising:
accessing a transaction data structure having transaction data for a plurality of merchants;
accessing a merchant data structure, the merchant data structure including multiple merchants and at least one category descriptor for each of the multiple merchants;
combining, by a computing device, data in the transaction data structure and the merchant data structure, based on a merchant identifier for a merchant common among at least one of the plurality of merchants in the transaction data structure and at least one of the multiple merchants in the merchant data structure;
assigning, by the computing device, at least one label to the common merchant based on at least one category descriptor for the common merchant in the merchant data structure; and
generating, by the computing device, a model for an MCC assigned to the common merchant, based on transaction data for the common merchant and the assigned at least one label, whereby the model can be used to verify assignment of the MCC to other merchants.

2. The computer-implemented method of claim 1, wherein the transaction data includes a transaction count, per interval, for each of the merchants in the transaction data structure and/or an average transaction amount per merchant.

3. The computer-implemented method of claim 1, wherein the at least one label is specific to the MCC assigned to the common merchant.

4. The computer-implemented method of claim 1, wherein the model includes at least one of a transaction count per hour associated with the MCC and/or an average credit share for the MCC.

5. The computer-implemented method of claim 4, wherein the MCC is specific to a bar, a restaurant, or a fast food restaurant.

6. The computer-implemented method of claim 1, further comprising scoring, by a different computing device, an assigned MCC for a merchant based on the generated model; and
causing, by the different computing device, the score to the transmitted to a payment network.

7. The computer-implemented method of claim 6, further comprising, when the scored MCC for said merchant fails to satisfy a predefined threshold, assigning a new MCC to said merchant.

8. The computer-implemented method of claim 1, wherein combining data in the transaction data structure and the merchant data structure includes:
one of appending the transaction data structure to the merchant data structure based on the merchant identifier and appending the merchant data structure to the transaction data structure based on the merchant identifier; and
filtering the combined data based on at least one MCC.

9. A system for use in modeling transaction data associated with merchant category codes (MCCs) assigned to merchants, the system comprising:
a memory including a transaction data structure and a merchant data structure comprising data for multiple merchants, the merchant data structure including category descriptors for at least a portion of the multiple merchants; and
a processor in communication with the memory, the processor configured to:
assign labels to the at least a portion of the multiple merchants based on the category descriptors included in the merchant data structure;
generate a model for at least one MCC assigned to the multiple merchants, based on the transaction data in the transaction data structure and the assigned labels for the at least a portion of the multiple merchants, the model including at least one transaction data parameter; and
deploy the model for use by at least one entity, whereby the model permits that at least one entity to evaluate the at least one MCC as assigned to one or more other merchants.

10. The system of claim 9, wherein the transaction data structure and the merchant data structure are included in a combined data structure; and
wherein the processor is configured to generate the model based on the combined data structure.

11. The system of claim 9, wherein the processor is further configured to combine the transaction data structure and the merchant data structure based on at least one merchant identifier.

12. The system of claim 11, wherein the processor is configured to retrieve the merchant data structure from a third party data provider.

13. The system of claim 11, wherein the at least one transaction data parameter of the model includes at least one of an average transaction count per hour, an average daily credit share, and an average daily transaction count.

14. The system of claim 13, wherein a first merchant is assigned the at least one MCC; and
wherein the system further comprises a computing device associated with the at least one entity, the computing device configured, in response to the model being deployed to the at least one entity, to:
access transaction data for the first merchant;
compare the at least one transaction data parameter of the model for the at least one MCC to the transaction data for the first merchant; and
assign a score to the first merchant for the at least one MCC indicative of the comparison, thereby providing a confidence in the assignment of the at least one MCC to the first merchant.

15. The system of claim 14, wherein the computing device associated with the at least one entity is configured to assign the score to the first merchant for the at least one MCC based on the model; and
wherein the at least one entity includes a payment network, including the processor, the memory, and the computing device.

16. The system of claim 14, wherein the computing device associated with the at least one entity is further configured to:
compare the score to a threshold; and
when the score fails to satisfy the threshold:
compare at least one transaction data parameter of another model for at least another MCC to the transaction data for the first merchant;
assign another score to the first merchant for the at least another MCC indicative of the comparison, thereby providing a confidence in the assignment of the at least another MCC to the first merchant; and
compare the another score to a threshold and assign the at least another MCC to the first merchant when the another score satisfies the threshold.

17. A non-transitory computer readable storage media including executable instructions for use in evaluating a merchant category code (MCC) assigned to a merchant that, when executed by at least one processor, cause the at least one processor to:
combine transaction data from a transaction data structure and merchant data from a merchant data structure for a merchant included in both data structures, said transaction data including a transaction count per interval for the merchant and/or an average transaction amount for the merchant, and said merchant data including a merchant name of the merchant and/or at least one category descriptor; and
assign a label to the merchant based on the at least one category descriptor, the label being specific to an MCC assigned to the merchant; and
generate a model for the MCC assigned to the merchant, based on the transaction data for the merchant and the assigned label, whereby the model is suited to verify assignment of the MCC to at least one other merchant.

18. The non-transitory computer readable storage media of claim 17, wherein the executable instructions, when executed by the processor, further cause the processor to deploy the model, whereby at least one entity is permitted to evaluate the MCC as assigned to the at least one other merchant based on the model.

19. The non-transitory computer readable storage media of claim 17, wherein the executable instructions, when executed by the processor, further cause the processor to:
retrieve the transaction data from a payment network associated with processing transactions initiated at the merchant; and
retrieve the merchant data from a third party data provider.

20. The non-transitory computer readable storage media of claim 19, wherein the transaction data includes a transaction count per multiple intervals, each of the multiple intervals being daily intervals.
